(19) United States
(12) Patent Application Publication
(10) Pub. No.: US 2003/0156806 A1
(43) Pub. Date: Aug. 21, 2003

(54) Filter

(76) Inventors: Kenichi Maruhashi, Tokyo (JP); Masaharu Ito, Tokyo (JP); Keiichi Ohata, Tokyo (JP)

Correspondence Address: SUGHRUE MION, PLLC, 2100 PENNSYLVANIA AVENUE, N.W., WASHINGTON, DC, 20037, US

(21) Appl. No.: 10/332,348

(22) PCT Filed: Jul. 6, 2001
(86) PCT No.: PCT/JP01/05893

(30) Foreign Application Priority Data
Jul. 7, 2000 (JP) 2000-207460

(51) Int. Cl. G02B 6/44

(52) U.S. Cl. 385/100

(57) ABSTRACT

The present invention provides a filter exhibiting excellent filter characteristics and having less number of stages. A dielectric substrate (1) has one surface connected to a top conductor (2) and an opposite surface connected to a bottom conductor (3). A pair of rows of via-holes connecting together the top conductor (2) and the bottom conductor (3) are formed along the signal transfer direction. A slit (6) is formed in a portion of the top conductor (2) overlying the central resonator among a plurality of resonators. The slit (6) extends in a direction perpendicular to the signal transfer direction. Slits (7, 8) are formed in each of portions of the top conductor (2) overlying resonators disposed at both ends. A coplanar waveguide (9) mounted on the top conductor (2) is connected to the slit (7).

### TECHNICAL FIELD

The present invention relates to a filter having a waveguide tube structure for use as a high-frequency component.

### TECHNICAL BACKGROUND

Typical waveguide tube filters used in microwave and millimeter-wave bands are realized by using a resonator structure including a metallic waveguide tube formed in a drawn structure. This type of the filters has a drawback in larger dimensions although it is superior in the performance thereof.

Thus, as recited in JP Patent Application 10-82184, a pseudo waveguide tube band-pass filter is devised which has a side wall of the waveguide tube configured by metallic via-holes in a dielectric substrate. As a practical example, FIGS. 9A and 9B show the schematic structure of a filter having a four-stage configuration. FIG. 9A is a perspective view thereof, whereas FIG. 9B is a top plan view thereof. A top conductor 2 is formed on one of the surfaces of the dielectric substrate 1, whereas a bottom conductor 3 is formed on the opposing surface thereof. Via-holes 4 connecting together the top conductor 2 and the bottom conductor 3 are formed in two rows along the signal transfer direction. The spacing “a” between adjacent via-holes is equal to or below ½ of the in-tube wavelength. This structure is construed as a pseudo waveguide tube having a waveguide tube cross section defined by the thickness of the dielectric and the spacing “b” between the two rows of the via-holes 5 arranged. Pairs of via-holes 5 are also formed in the waveguide tube to configure resonators having cavity lengths of L1, L2, L3 and L4. By suitably selecting the spacing “c” between the via-holes 5 forming a pair, frequencies other than the resonant frequency can be effectively reflected. On the other hand, a signal in the resonant frequency passes therethrough to achieve a desired filter function. In this filter, the dimensions of the filter are reduced down to about 1/\sqrt{ε} compared to a waveguide tube having a hollow interior (ε is the relative permittivity of the dielectric).

On the other hand, a filter is often used which is configured by using a micro-strip line on a dielectric substrate. This filter has relatively smaller dimensions and can be connected to a planar circuit, such as an integrated circuit, by wire bonding, thereby allowing the filter to be mounted in a high-frequency module with ease.

The above waveguide tube filer is sometimes requested to have smaller dimensions. For example, the dimensions of the microwave or millimeter-wave integrated circuit formed on a semiconductor device are of around 5 mm square at a maximum. Accordingly, if a small-size multi-chip module is to be implemented by using an integrated circuit, it is generally important to reduce the dimensions of passive components such as a filter. In addition, it is generally difficult to connect the filter to a planar circuit. Thus, a filter is desired which can be mounted and connected with ease and without enlarging the dimensions and adding a particular conversion circuit.

On the other hand, the filter using the micro-strip line sometimes assumes a characteristic change upon mounting the filter in a package structure. This results from the fact that the electromagnetic field in the micro-strip line is distributed up to the top portion thereof and thus liable to the influence by attaching a cap member thereto.

In the connection structure using the wire bonding technique, especially in the higher frequency range such as millimeter wave band, there arises a characteristic change caused by variation of the wire length or by variation of the parasitic inductance component determined by the wire length. Such a characteristic change is not negligible, and becomes a factor of reducing the product yield in a mass production. For solving this problem, a flip-chip mounting technique has been developed wherein the millimeter-wave semiconductor integrated circuit is mounted with face-down mounting onto a mounting board and connected thereto by using bumps. This technique is described in a literature, “IEEE International Solid-State Circuits Symposium, Digest” pp.324-325, 2000, by K. Maruhashi et al., for example. When the flip-chip mounting technique is applied, the connection between each element and the mounting board is implemented by a relatively short distance (200 micrometers or less), whereby the influence by the parasitic inductance component and variation thereof which is generally a matter of problem in the wire bonding technique becomes negligible. For applying the flip-chip mounting technique to the filter as well, the filter should have a terminal adapted to a coplanar waveguide, which is generally used for connection between elements, and should have a structure wherein the face-down mounting scarcely changes the filter characteristic, and thus such a filter has been strongly desired.

### SUMMARY OF THE INVENTION

In view of the above, it is an object of the present invention to provide a small-dimension filter having a dielectric waveguide tube structure and excellent filter characteristics even in the case of a smaller number of stages, and to provide a filter capable of being mounted by a flip-chip mounting technique without providing a particular external terminal thereto for connection with a planar circuit.

The present invention provides, in a first aspect thereof, a filter including a rectangular waveguide tube structure filled with dielectric, wherein the rectangular waveguide structure configures therein at least one resonator, characterized in that:

at least one slit is formed in a longer-side conductor plane of the waveguide tube structure.

The present invention provides, in a second aspect thereof, a filter including a rectangular waveguide tube structure including a pair of first conductor planes formed on top and bottom surfaces of a dielectric substrate, and a pair of second conductor planes formed on side surfaces of the dielectric substrate, wherein the first conductor planes constitute longer-side conductor planes, and the rectangular waveguide tube structure configures therein at least one resonator, characterized in that:

at least one slit is formed in one of the longer-side conductor planes of the waveguide tube structure.

The present invention provides, in a third aspect thereof, a filter including a rectangular waveguide tube structure including a pair of conductor planes formed on top and bottom surfaces of a dielectric substrate, conductor via-holes formed in the dielectric substrate, wherein the conductor planes constitute longer-side conductor planes, and the rectangular waveguide tube structure configures at least one resonator, characterized in that:

at least one slit is formed in one of the longer-side conductor planes of the waveguide tube structure.

In accordance with the filters of the present invention, it is preferable that the slit be formed in a portion of the longer-side conductor plane of the waveguide tube structure configuring a central resonator among an add number of resonators arranged.

In addition, it is preferable the slit extend in a direction perpendicular to the signal transfer direction.

It is also preferable that the conductor plane configuring the waveguide tube structure mount thereon a coplanar waveguide, and the coplanar waveguide be connected to the slit. In such a case, the coplanar waveguide and a circuit board for mounting thereon the filter are connected together via a bump.

It is also preferable that the conductor plane configuring the waveguide tube structure mounts thereon a slot line, and the slot line be connected to the slit. In such a case, the slot line and a circuit board mounting thereon the filter be connected together via a bump.

### BRIEF DESCRIPTION OF THE DRAWINGS

FIGS. 1A and 1B show the configuration of a filter according to a fourth embodiment of the present invention, wherein FIG. 1A is a perspective view and FIG. 1B is a top plan view.

FIGS. 2A and 2B show a configuration of a filter according to a first embodiment of the present invention, wherein FIG. 2A is a perspective view and FIG. 2B is a top plan view.

FIG. 3 is a graph showing the filter characteristic of the first embodiment of the present invention.

FIGS. 4A and 4B show the configuration of a filter according to a second embodiment of the present invention, wherein FIG. 4A is a perspective view and FIG. 4B is a top plan view.

FIG. 5 is an explanatory view of the mounting structure of the filters according to the second and fourth embodiments of the present invention.

FIG. 6 is another explanatory view of the mounting structure of the filters according to the second and fourth embodiments of the present invention.

FIGS. 7A and 7B show a filter according to a third embodiment of the present invention, wherein FIG. 7A is a perspective view and FIG. 7B is a top plan view.

FIG. 8 is an explanatory view of the mounting structure of the filter according to the third embodiment of the present invention.

FIGS. 9A and 9B show a conventional filter, wherein FIG. 9A is a perspective view and FIG. 9B is a top plan view.

### BEST MODES FOR WORKING THE INVENTION

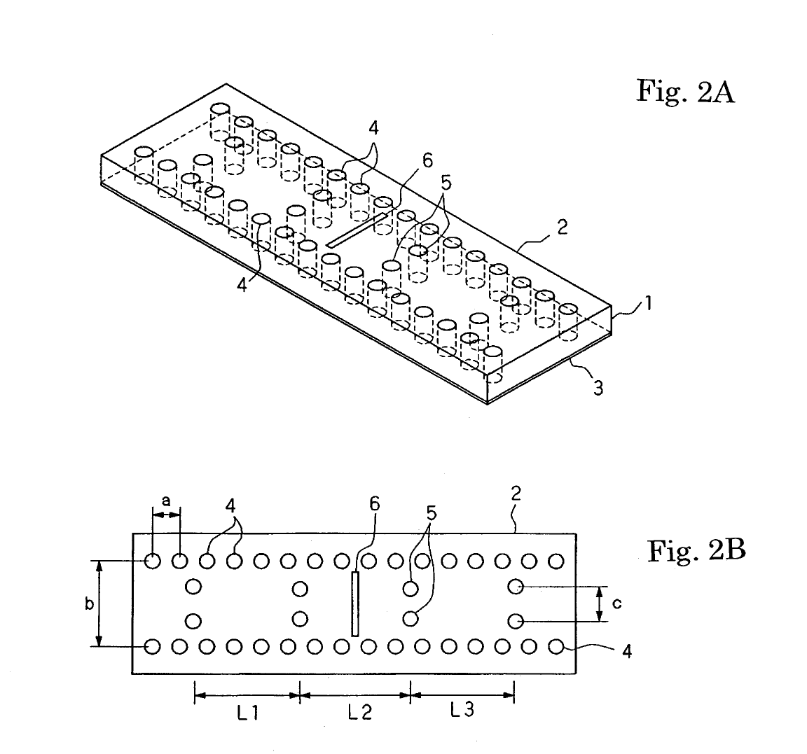

Hereinafter, the present invention is more specifically described based on the preferred embodiments thereof with reference to the drawings. Referring to FIGS. 2A and 2B, there is shown the schematic structure of a filter according to a first embodiment of the present invention. A dielectric substrate 1 is provided with a top conductor 2 formed on a surface thereof, and a bottom conductor 3 formed on the opposing surface thereof. Via-holes 4 connecting together the top conductor 2 and the bottom conductor 3 are formed in two rows along a signal transfer direction. The spacing “a” between adjacent via-holes is preferably equal to or below ½ of the in-tube wavelength. This structure can be construed as a pseudo waveguide tube having a waveguide-tube cross section defined by the thickness of the dielectric substrate (in a shorter side) and the spacing between the two rows of the via-holes arranged (in a longer side). In the waveguide tube, pairs of via-holes 5 are further formed, thereby configuring resonators having cavity lengths of L1, L2 and L3. By suitably selecting the spacing “c” between the via-holes 5 forming a pair, frequencies other than a resonant frequency can be reflected. On the other hand, a signal in the resonant frequency passes therethrough to achieve a desired filter property.

The present filter has a three-stage structure including three resonators therein, wherein a portion of the top conductor 2 overlying the central resonator is provided with a slit 6 formed by partially removing the conductor. The slit 6 is preferably arranged to extend in a direction perpendicular to the signal transfer direction.

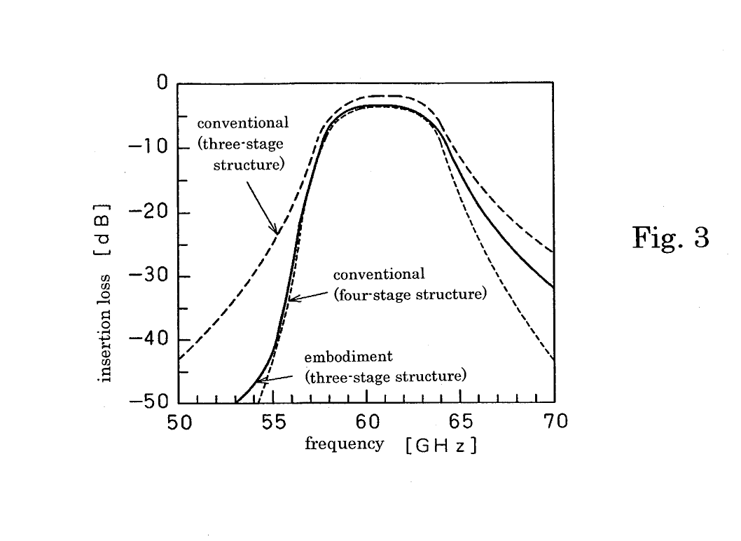

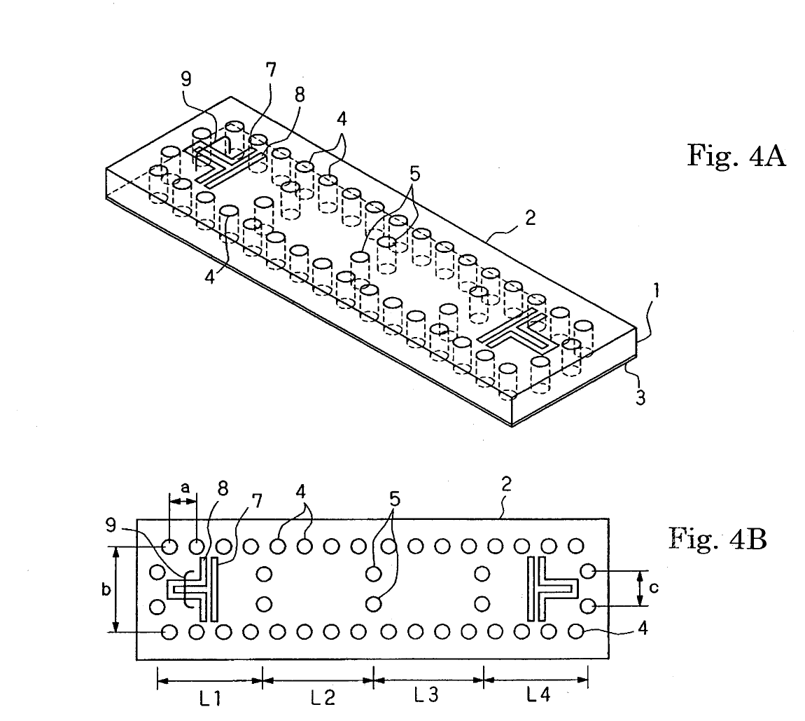

FIG. 3 shows the filter characteristic (insertion loss) in the present embodiment. The characteristics of the frequency dependency of the insertion loss of conventional filters are also exemplified, which include a filter having four stages similarly to the filter shown in FIG. 4 and a filter having three stages (not specifically shown in the drawings), both having a 3-dB pass band similar to the 3-dB pass band of the present embodiment. For example, the insertion loss in the present embodiment is 40 dB at a frequency (55 GHz) which is 6 GHz apart from the central frequency, 61 GHz, toward a lower frequency side. This value is higher than the insertion loss, 25 dB, of the conventional three-stage filter and is approximately equal to the value, 42 dB, of the conventional four-stage filter. That is, according to the present embodiment, an excellent suppression amount for the undesired-frequency-band signal is obtained even in the case of using a less number of stages compared to the conventional technique. Accordingly, the filter has smaller dimensions, whereby lower costs for the filter itself or smaller dimensions of a high-frequency circuit module having such a filter can be achieved.

The operational principle of the present embodiment is that the introduction of the slit 6 provides an attenuation pole in the lower frequency range to thereby raise the suppression amount of the undesired-frequency-band signal. In the present embodiment, the attenuation pole is formed in the lower frequency range; however, the attenuation pole may be formed in the higher frequency range by adjusting the slit length. It is found that the frequency at which the attenuation pole appears is easily adjusted, without changing the other structural parameters, by changing the slit length for the slit provided above the central resonator among an odd number of the resonators provided in the filter. In addition, the slit may extend between the via-holes 4, if desired, and can be extended beyond the waveguide tube structure by increasing the length thereof, and accordingly, a higher design choice can be obtained. Moreover, by providing slits having different lengths above a plurality of resonators, attenuation poles can be provided on both the higher frequency side and the lower frequency side.

It is to be noted that although the signal electromagnetic field leaks from the internal of the pseudo waveguide tube through the slit, the influence by the signal electromagnetic field is lower due to the dielectric residing within the pseudo waveguide tube. Accordingly, if it is incorporated in a module, for example, and covered by a cap, the influence to the filter characteristic is lower.

The filter of the present embodiment can be easily manufactured by using a well-known alumina-ceramic-substrate process etc. More specifically, the filter may be manufactured, while using a ceramic-material sheet, by the steps of forming via-holes, filling therein with metallic paste, baking, forming an interconnection film (forming slit), plating with gold etc. It is to be noted that the material for the substrate, the process for forming the via-holes and the process for forming the slit are not limited in the present invention. In addition, although the via-holes 4 are exemplarily formed in two rows along the signal transfer direction, any number of rows may be employed so long as the pseudo waveguide tube is configured thereby.

Referring to FIGS. 4A and 4B, there is shown the schematic structure of a filter according to a second embodiment of the present invention. A dielectric substrate is provided with a top conductor 2 formed on one surface thereof, and a bottom conductor 3 formed on the opposite surface thereof. Via-holes 4 connecting the top conductor 2 and the bottom conductor 3 together are formed in two rows along the signal transfer direction. It is preferable that the spacing “a” between adjacent via-holes be equal to or less than ½ of the in-tube wavelength. This structure can be construed as a pseudo waveguide tube having a waveguide-tube cross section defined by the thickness of the dielectric and the spacing “b” between the two rows of the via-holes arranged. In addition, pairs of via-holes 5 are formed in the waveguide tube to thereby configure resonators having cavity lengths of L1, L2, L3 and L4. By suitably selecting the spacing “c” between the via-holes 5 forming a pair, frequencies other than the resonant frequency can be reflected. On the other hand, a signal in the resonant frequency passes therethrough to thereby obtain a desired filter performance. The present filter has a four-stage structure including four resonators therein, wherein each of portions of the top conductor 2 overlying the outermost end resonators is provided with slits 7 and 8 formed by partially removing the conductor. A coplanar waveguide 9 formed on the top conductor 2 overlying the resonator is connected to the slit 7.

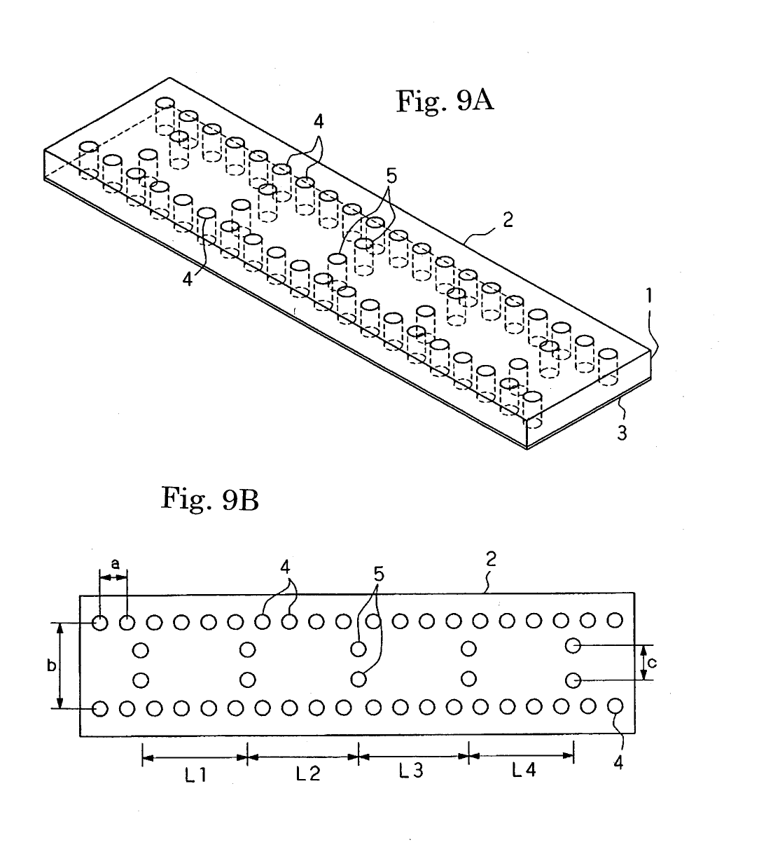

In accordance with the second embodiment of the present invention, the coplanar waveguide 9 formed overlying the resonator constitutes a terminal for external connection. Accordingly, it can be manufactured with reduced dimensions compared to the conventional technique (FIG. 9) which necessitates another terminal in the signal transfer direction. In addition, it can be connected to a planar circuit by using a bonding wire technique without using an additional particular conversion section. It is to be noted that although the signal electromagnetic field leaks from the internal of the pseudo waveguide tube through the slit, the influence thereby is lower due to the dielectric residing within the pseudo waveguide tube. Accordingly, if it is incorporated in a module, fore example, and covered by a cap, the influence to the filter characteristic is lower.

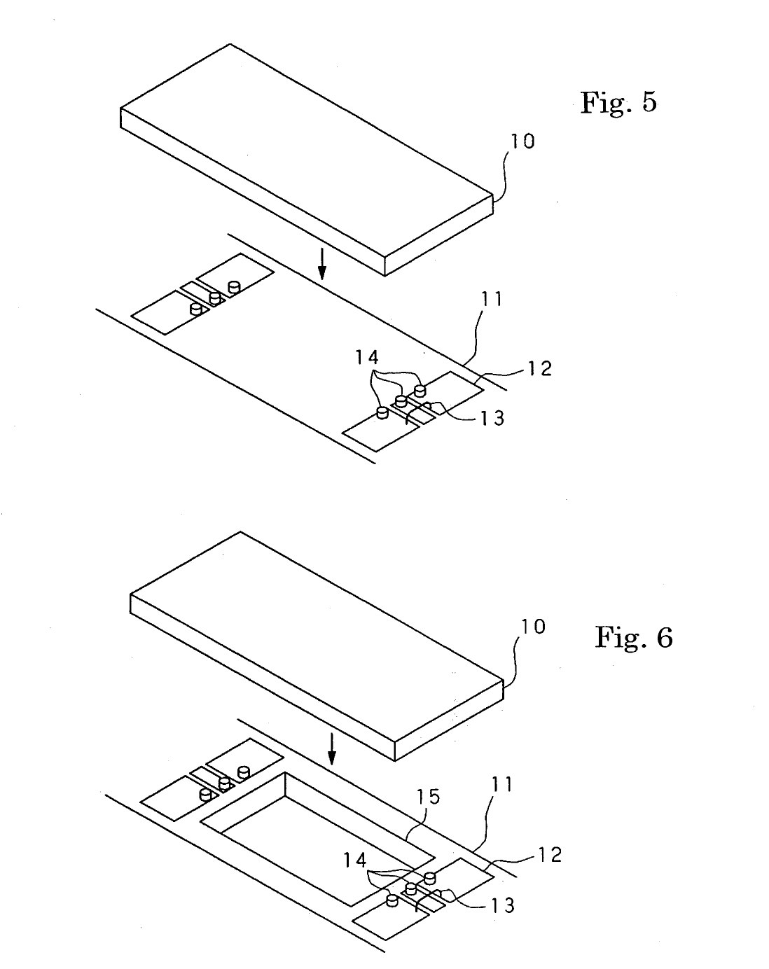

FIG. 5 shows the mounting technique used for the filter according to the present embodiment. A coplanar waveguide 13 is formed using a conductor pattern 12 on the mounting board 11, on which the filter 10 of the present embodiment is to be mounted. For example, bumps 14 including gold as a main component thereof are formed on the mounting board 11. The filter is mounted on and connected to the mounting board 11 via bumps. Onto this mounting board, an integrated circuit etc. may be sometimes mounted other than the recited filter. In the present invention, the species or fabrication method of the bums are not particularly defined, and thus solder bumps can be used, and the bumps may be formed on the filter side without any problem. In this mounting technique, although the mounting board affects the electromagnetic field leaking through the slit, the influence thereby is relatively lower due to the dielectric residing within the pseudo waveguide tube. For further reducing this influence, it is possible to provide a depression in the area of the mounting board 11 in which the filter is to be mounted, for example. As described above, in the filter according to the embodiment of the present invention, a characteristic change between before and after the mounting process can be suppressed, whereby advantages of the flip-chip mounting technique can be obtained substantially without problems of the parasitic inductance component and variation thereof, which are generally involved in the wire bonding process.

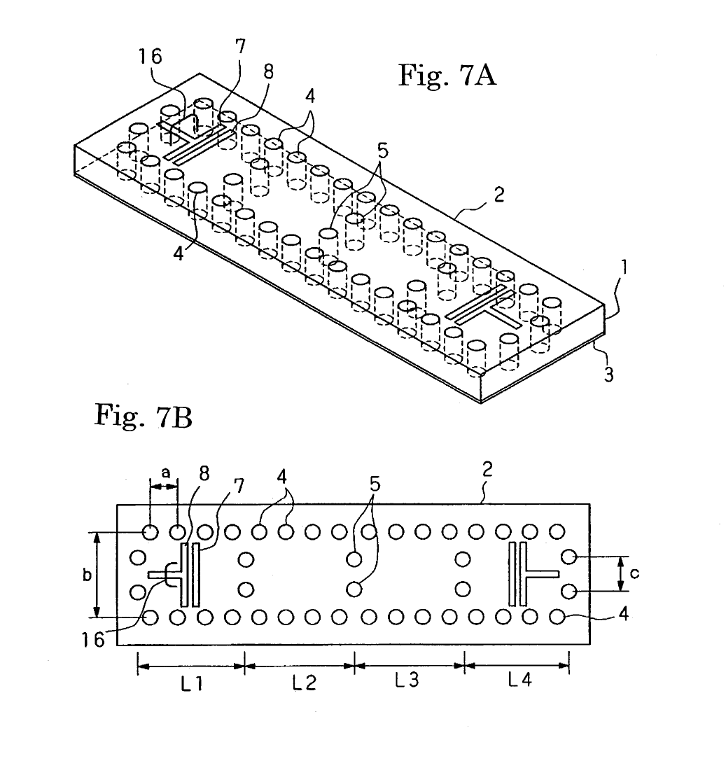

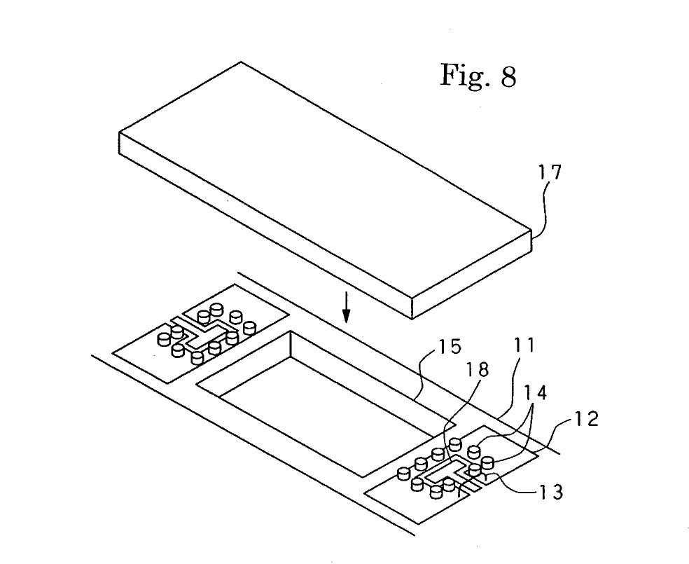

Referring to FIGS. 7A and 7B, there is shown the schematic structure of a filter according to a third embodiment of the present invention. The present filter has a main structure similar to that of the filter shown in FIG. 4, wherein a slot line 16 is connected to the slit 7 while overstriding the slit 8. FIG. 8 shows an example of the mounting process of the filter according to the present embodiment. A coplanar waveguide 13 using a conductor pattern 12 is formed on the mounting board 11 on which the filter 10 according to the present embodiment is to be mounted. A slot line/coplanar waveguide conversion section 18 is formed on the tip of the coplanar waveguide. In addition, bumps 14 including gold as a main component thereof are formed on the mounting board 11. The filter is mounted on the mounting board 11 via bumps 14 by using a heat-press technique, for example. In this technique, the slot line formed on the filter is connected to the coplanar waveguide on the mounting board via the slot line/coplanar waveguide conversion section 18 with an electromagnetic field coupling. As a result, a characteristic change between before and after the mounting process can be suppressed, similarly to the second embodiment, and the advantages of the flip-chip mounting technique can be obtained substantially without the problems of the influence by the parasitic inductance component and the variation thereof, which are generally involved in the wire bonding technique.

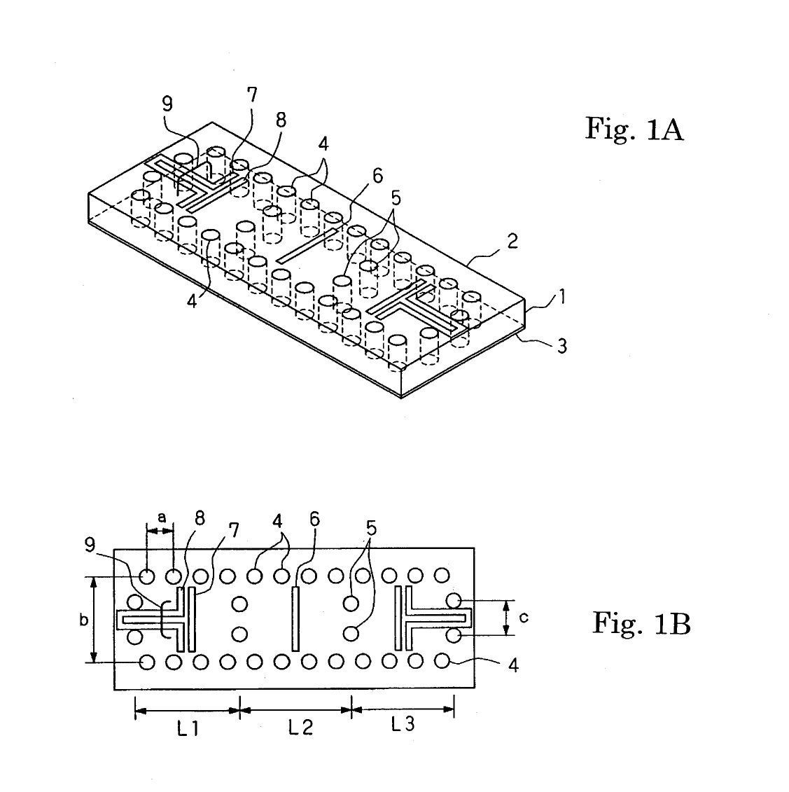

Referring to FIGS. 1A and 1B, there is shown the schematic structure of a filter according to a fourth embodiment of the present invention. This embodiment best exhibits the features of the present invention. A dielectric substrate 1 is provided with a top conductor 2 formed on one surface thereof, and a bottom conductor 3 formed on the opposite surface thereof. Via-holes 4 connecting together the top conductor 2 and the bottom conductor 3 are formed in two rows along the signal transfer direction. The spacing “a” between adjacent via-holes is preferably equal to or smaller than ½ of the in-tube wavelength. This structure is construed as a pseudo waveguide tube having a waveguide-tube cross section defined by the thickness of the dielectric and the spacing “b” between two rows of the via-holes arranged. In addition, pairs of via-holes 5 are formed in the waveguide tube to configure resonators having cavity lengths of L1, L2 and L3. By suitably selecting the spacing “c” between the via-holes 5 forming a pair, frequencies other than the resonant frequency can be reflected. On the other hand, a signal in the resonant frequency passes therethrough to thereby obtain a desired filter property.

The present filter has a three-stage structure including three resonators therein, wherein a portion of the top conductor 2 overlying the central resonator is provided with a slit 6 formed by partially removing the conductor. It is preferable that the slit 6 be arranged to extend in the direction perpendicular to the signal transfer direction. Each portion of the top conductor 2 overlying the outermost end resonator is provided with slits 7 and 8 formed by partially removing the conductor. A coplanar waveguide 9 is connected to the slit 7. According to the present embodiment, smaller dimensions and lower costs for the filter can be achieved, and the flip-chip bonding technique can be applied thereto, as recited in connection with the descriptions for the first and second embodiments.

According to the first aspect of the present invention, by the configurations wherein a resonator is formed in the rectangular waveguide tube filled with dielectric, and wherein a slit is formed in the longer-side conductor plane of the waveguide structure configuring the resonator, an attenuation pole is configured which improves the suppression performance for the out-of-band signal, whereby the undesired-frequency-band signal can be suppressed in the filter. This allows reduction of the number of stages of the filter to reduce the dimensions thereof, whereby the filter can be manufactured with ease and with lower costs.

The slit, as formed in the waveguide tube structure filled with dielectric, allows reduction of the leakage of the electromagnetic field through the slit due to the electromagnetic field residing mainly within the dielectric, to thereby reduce the influence to the filter characteristic.

According to the second aspect of the present invention, the slit, as formed in the longer-side conductor plane of the waveguide tube configuring the resonator, generates an attenuation pole which improves the suppression performance of the out-of-band signal, whereby the undesired-frequency-band signal can be suppressed in the filter. This allows reduction of the dimensions, fabrication feasibility and lower costs of the filter, similarly to the case of the first aspect of the present invention, whereby influence to the filter characteristic can be reduced even in the case of the filter being mounted in a high-frequency module.

According to the third aspect of the present invention, the slit, as formed in the longer-side conductor plane of the waveguide tube structure configuring the resonator, generates an attenuation pole which improves the suppression property for the out-of-band signal, whereby the undesired-frequency-band signal can be suppressed in the filter. This allows reduction of the dimensions, fabrication feasibility and lower costs of the filter, similarly to the cases of the first and second aspect of the present invention, whereby influence to the filter characteristic can be reduced in the case of the filter being mounted in a high-frequency module.

In the filter of the present invention, if an odd number of the resonators are arranged, and the slit is formed in a portion of the longer-side conductor plane of the waveguide tube structure overlying the central resonator among them, the attenuation pole can be adjusted due to the symmetry without degrading the filter characteristic, thereby providing a filter wherein the frequency at which the attenuation pole appears can be easily adjusted.

In addition, the slit, as formed in the longer-side conductor plane of the waveguide tube structure and extending in the direction perpendicular to the signal transfer direction, allows an efficient adjustment of the frequency at which the attenuation pole appears.

The coplanar waveguide, as formed in the conductor plane configuring the waveguide tube structure and connected to the slit, allows connection to a planar circuit without providing a particular external terminal or using a long-distance wire for connecting to the terminal, whereby the filter can be reduced in the dimensions thereof.

The structure, wherein the coplanar waveguide on the filter and the circuit board on which the filter is mounted are connected together via bumps, allows performing the flip-chip mounting with ease, thereby reducing the man-hours and allowing excellent reproducible connection in the higher-frequency range.

The structure, wherein the slot line is formed in the conductor plane configuring the waveguide tube structure and connected to the slit, allows connection to a planar circuit without providing a particular external terminal and using a long-distance wire for connecting to the terminal, thereby forming the filter in smaller dimensions.

The structure, wherein the slot line on the filter and the circuit board on which the filter is mounted are connected together via bumps, allows performing the flip-chip mounting process with ease, thereby reducing man-hours and allowing excellent reproducible connection in the high-frequency range.

1. A filter comprising a rectangular waveguide tube structure filled with dielectric, wherein said rectangular waveguide structure configures therein at least one resonator, characterized in that:
at least one slit is formed in a longer-side conductor plane of said waveguide tube structure.

2. A filter comprising a rectangular waveguide tube structure including a pair of first conductor planes formed on top and bottom surfaces of a dielectric substrate, and a pair of second conductor planes formed on side surfaces of said dielectric substrate, wherein said first conductor planes constitute longer-side conductor planes, and said rectangular waveguide tube structure configures therein at least one resonator, characterized in that:
at least one slit is formed in one of said longer-side conductor planes of said waveguide tube structure.

3. A filter comprising a rectangular waveguide tube structure including a pair of conductor planes formed on top and bottom surfaces of a dielectric substrate, conductor via-holes formed in said dielectric substrate, wherein said conductor planes constitute longer-side conductor panes, and said rectangular waveguide tube structure configures therein at least one resonator, characterized in that:
at least one slit is formed in one of said longer-side conductor planes of said waveguide tube structure.

4. The filter according to any one of claims 1 to 3, wherein an odd number of said resonator are arranged, and said slit is formed on a portion of said longer-side conductor plane of said rectangular waveguide tube structure configuring a central one of said resonators.

5. The filter according to any one of claims 1 to 4, wherein said slit extends in a direction perpendicular to a signal transfer direction.

6. The filter according to any one of claims 1 to 5, wherein a coplanar waveguide is connected to one of conductor planes configuring said waveguide tube structure, and said coplanar waveguide is connected to said slit.

7. The filter according to claim 6, wherein said coplanar waveguide is connected via a bump to a circuit board for mounting thereon said filter

8. The filter according to any one of claims 1 to 5, wherein a slot line is connected to one of conductor planes configuring said waveguide tube structure, and said slot line is connected to said slit.

9. The filter according to claim 8, wherein said slot line is connected via a bump to a circuit board for mounting thereon said filter.
